(19) United States
(12) Patent Application Publication
(10) Pub. No.: US 2009/0261832 A1
(43) Pub. Date: Oct. 22, 2009

(54) ELECTROMAGNETIC-SEISMIC LOGGING SYSTEM AND METHOD

(76) Inventors: Luis Eduardo DePavia, Sugar Land, TX (US); David Alumbaugh, Berkeley, CA (US)

Correspondence Address: SCHLUMBERGER OILFIELD SERVICES, 200 GILLINGHAM LANE, MD 200-9, SUGAR LAND, TX, 77478, US

(21) Appl. No.: 12/421,344

(22) Filed: Apr. 9, 2009

Related U.S. Application Data
(60) Provisional application No. 61/046,826, filed on Apr. 22, 2008.

(51) Int. Cl. G01V 3/12

(52) U.S. Cl. 324/338

(57) ABSTRACT

An EMI-Seismic logging tool for use in a subterranean formation penetrated by a well bore, wherein the system makes electromagnetic and seismic measurements simultaneously using an EM receiver array for both measurements. A method of simultaneously making electromagnetic and seismic measurements in a subterranean formation is also provided.

### TECHNICAL FIELD

The invention relates generally to seismic and electromagnetic (EM) measurements, and in particular, to the use of an EM receiver functioning as a seismic receiver.

### BACKGROUND

Electromagnetic (EM) logging tools are commonly used to measure conductivity of rock formations, providing the means to identify the presence of water or hydrocarbons. Seismic tools on the other hand, measure the propagation velocity of mechanical waves through different rock formations as means to detect geological structures and rock properties such as porosity. Both Electromagnetic logging tools and seismic logging tools are common in the industry and have been patented.

In existing systems, EM surveys are logged without seismic surveys. When seismic information is required, then a fully separate profile and service is required such as cross-well seismic survey taken with a seismic tool such as Schlumberger's Versatile Seismic Imager™ tool. Electromagnetic and seismic measurements are complementary and help in the processing and interpretation of a reservoir.

### BRIEF DESCRIPTION OF THE DRAWINGS

FIG. 1 is a representation of the equipment arrangement in standard cross well EM tomography.

FIG. 2 is a representation of the equipment arrangement in an EM-seismic system.

FIG. 3 shows a graphical response of a plurality of receivers in an array in a station, as shown in FIG. 2, while the EM transmitter is switched to “OFF.”

### DETAILED DESCRIPTION

In the following description, numerous details are set forth to provide an understanding of the present invention. However, it will be understood by those skilled in the art that the present invention may be practiced without these details and that numerous variations or modifications from the described embodiments are possible.

The present disclosure pertains to a system that makes EM and seismic measurements substantially simultaneously using an EM receiver array for both measurements. The substantially simultaneous EM/seismic measurements are accomplished based on the fact that the receivers measure a varying magnetic field. The variation in magnetic field sensed by the receiver has at least three sources: 1) an alternating source (Electromagnetic Transmitter); 2) receiver motion in the presence of an EM field; and 3) motion of the formation relative to the Receiver (when the transmitter string is mechanically insulated from the formation).

The alternating source, i.e., the EM Transmitter is used as part of existing EM logging tools, whereas the variation in field due to motion of the receiver and motion of the formation provides the bases on which the technological advances of the present invention are based. The advantages enabled by the present disclosure include considerable reduction in field equipment, rig time, personnel, accurate co-location of EM and seismic sensor and the possibility to modulate the EM signals with mechanical energy with its associated benefits.

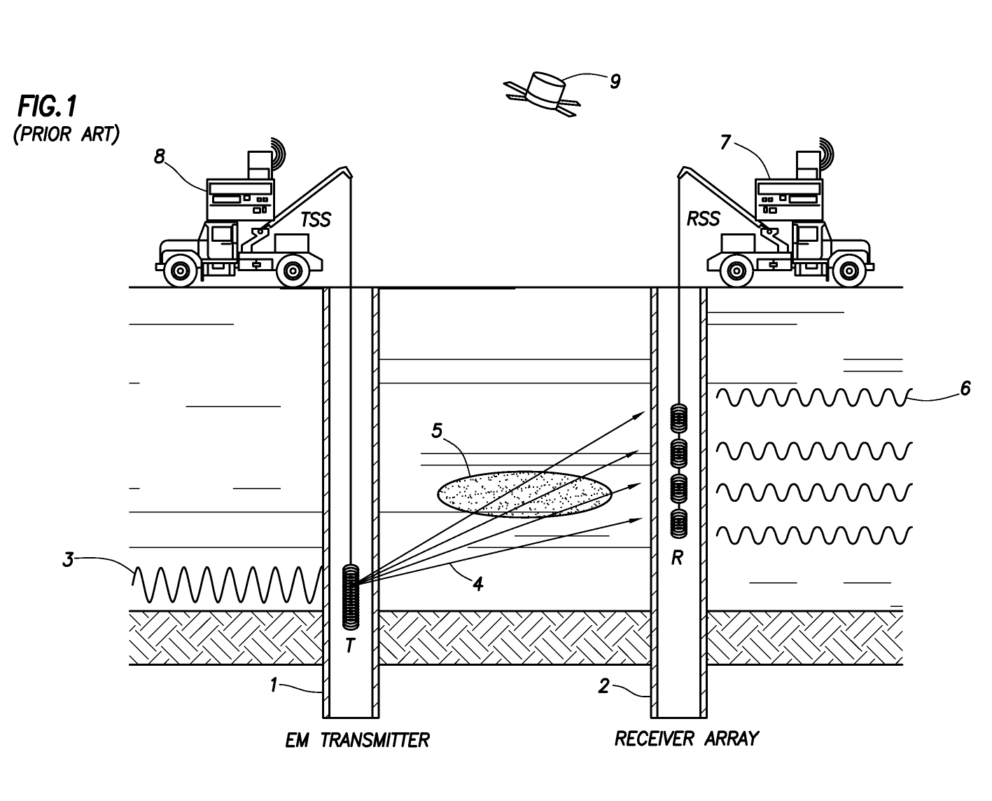

In a standard cross well EM tomography (shown in the prior art FIG. 1), the Electromagnetic (EM) Transmitter 1 generates an alternating magnetic field 3 which travels through the rock formation 4 and generates a secondary field in a water-filled formation 5 for example. The EM receiver array 2 senses the EM signal amplitude and phase 6. The EM signal amplitude and phase measured by the receiver array 2 can be processed through an inversion to provide a resistivity distribution between the wells. The EM Transmitter 1 and EM Receiver array 2 are physically independent of one another, yet are synchronized with respect to an absolute reference via a synchronization means, including GPS 9 (or other synchronization means, such as coupling via cable). The data is acquired at each string by a surface acquisition system (7 and 8 respectively, provided, for example, as shown on a wireline truck, or otherwise installed at the surface in a “while drilling” environment).

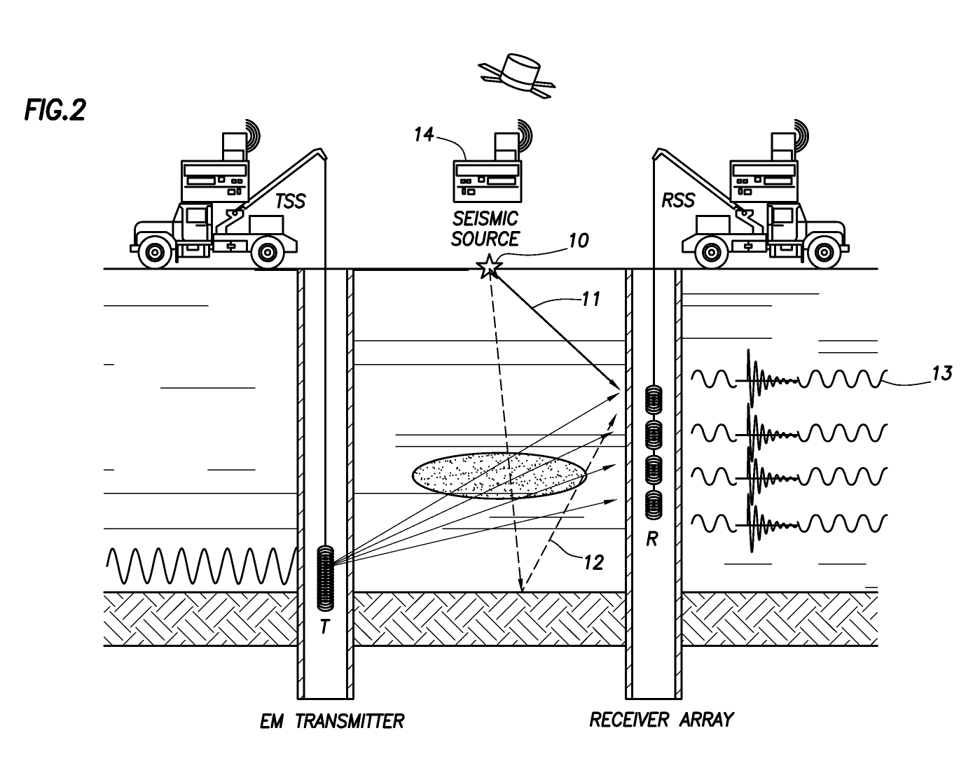

In the illustrative EM-Seismic system shown FIG. 2, a seismic source 10 is added to the EM logging system of FIG. 1. The seismic source 10 is synchronized through GPS 9 and linked wirelessly to the EM system through still another surface acquisition system 14. The seismic source is activated at predetermined time intervals, generating mechanical energy that propagates through rock formation 4. The seismic waves reach the EM receiver array 2 directly as shown in a downward-moving direct arrival 11 and as reflections, such as the reflected upward-moving primary 12. Under some circumstances, seismo-electric conversions may be generated. The seismic signal produces a high frequency perturbation 13 in the EM signal received by the EM receiver array 2. Since the full system is accurately synchronized (for example, to within a micro-second), and the EM Receiver array 2 digitizes the measured signal at high sampling rage (e.g., 25,000 sps) and continuously, the seismic signals can be clearly distinguished and accurate arrival times can be determined. The seismic signals separated from the EM signals can then be processed to extract rock structure information without separately conducting a seismic measurement (which would generally require tripping the EM array out of the well, and inserting a seismic imaging tool in the well instead).

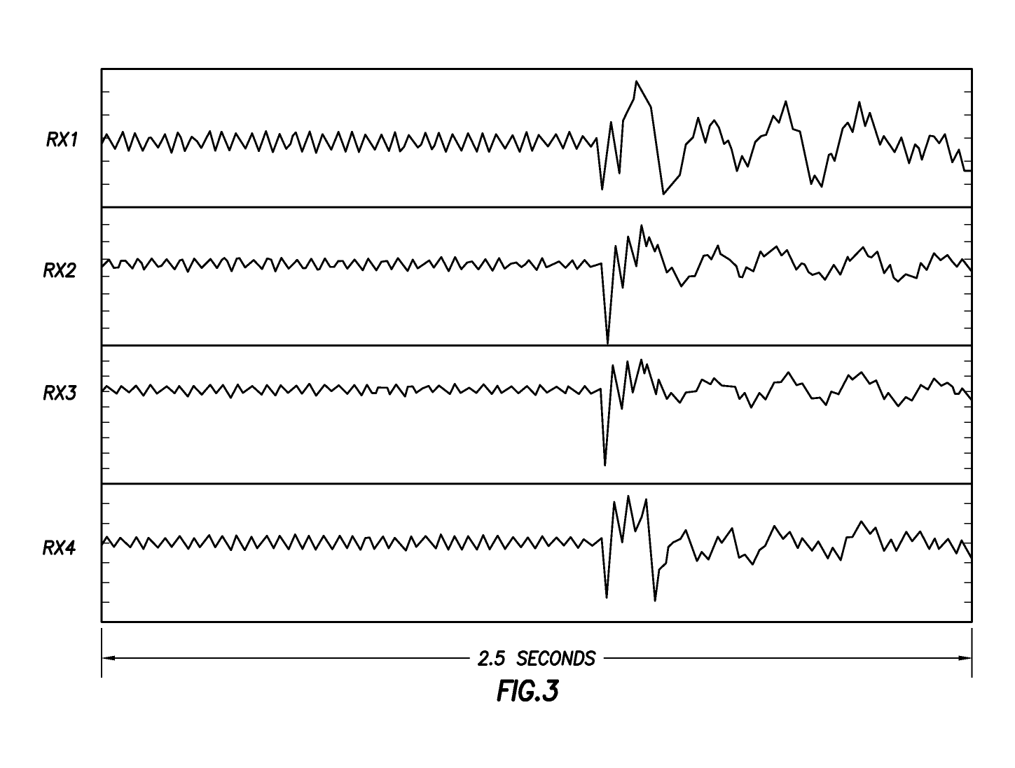

FIG. 3 shows the response for an embodiment employing four EM receivers in an array in a station, the EM receivers being sensitive to mechanical motion, vibration and/or rotation. The response of FIG. 3 shows a mechanical perturbation sensed by the four EM receivers in the array RX1-4. The perturbation is present as a sharp transition which then decays gradually.

The EM-seismic system described above with respect to FIG. 2 is used as part of a Wireline service, in which the EM transmitter 1 is deployed in one well, the EM receiver array 2 is deployed in another well and the seismic source 10 is deployed on surface, however the premise of the system can be applied to other environments and configurations such as while drilling (i.e., non-wireline configurations), surface EM transmitters and/or EM receivers, embodiments having the EM transmitter and EM receiver array in the same well, and any combination of transmitter (EM and/or seismic) and receivers in multiple locations (surface, downhole, and/or sea-bed).

Alternative Embodiments may include the following:

Receivers may be mechanically isolated from or tightly coupled to the formation. For example, the EM receiver array may be mechanically isolated from the formation. In such an embodiment, the EM receiver array is suspended by the wireline cable to the surface and kept mechanically isolated from the wellbore walls through soft centralizers. With such an embodiment, the seismic signals measured by the EM receiver array are the product of the motion from the formation relative to the receiver.

In such an embodiment, the rock formation (water saturated for example) produces a secondary EM field, and when the seismic waves produce motion in the formation, the secondary field reveals a variation with the characteristics (i.e., amplitude and phase) of the seismic wave. While the measurement of the secondary field is being made, the EM transmitter is powered ON at a determined power level and frequency (generating a primary field). The EM receiver array measures a varying EM signal which is “modulated” by the mechanical seismic waves produced by the seismic source as well as any seismo-electric conversions.

The amplitude of the EM transmitter can be adjusted in order to control the level of sensitivity of the EM receiver array to the seismic waves. Such an embodiment is simple to deploy since each receiver is coupled to the others mechanically by the wireline cable (i.e., in the standard wireline method) while being mechanically isolated from the formation, allowing each receiver to independently sense the response of the formation surrounding it.

In still another embodiment, the EM receiver array may be mechanically clamped to the formation. In such an embodiment, each receiver may have tight mechanical coupling with the adjacent rock formation. Such coupling is achieved through a mechanical clamping mechanism (such as that used with Schlumberger's Versatile Seismic Imager™ tool) and each receiver de-coupled from the others by connecting each receiver with a soft cable. Such an embodiment seeks to measure the seismic signals by directly coupling the mechanical energy into the receiver. When each receiver in the array is in the presence of a magnetic field (such as the Earth's magnetic field), then the motion response obtained is similar to that of an EM signal varying at the frequency of the mechanical motion, vibration and/or rotation.

In still another embodiment, the type and position of the seismic source(s) respect to the receivers can be varied from that shown in FIG. 2. The seismic source can be any of various different types, including but not limited to, air-guns, vibrating trucks, explosives, sound sources, drilling bit sound from another well, artificial or natural fractures, fluid injection induced micro-earthquakes. The seismic source can be deployed on surface at a single point (analogous to an Offset Vertical Seismic Profile (“VSP”) seismic survey), or multiple points (such as a deviated well VSP) or around (a walkaway VSP) and/or downhole.

In still another embodiment, the type and position of the EM transmitter sources and position respect to the receivers can be varied from that shown in FIG. 2. The EM transmitters can be any of various different types such as (but not limited to) wireline EM transmitter, surface electrodes, or the Earth's naturally occurring magnetic field.

The EM-Seismic system and method presented here can be used but is not limited to the following applications:
Determining reservoir depth, extent and heterogeneity;
Performing time-lapse analysis to reveal changes in the position of fluid contacts, changes in fluid content, and other variations such as pore pressure, particularly when water alternate gas injection schemes are used;
Determining fluid content, rock mechanical properties, pore pressure, enhanced oil-recovery progress, induced-fracture geometry and natural-fracture orientation and density;
Confirming and validating changes detected in pure EM time-lapse analysis based on electromagnetic tomography;
Applications which require a broad bandwidth and/or high resolution of downhole seismic signals in a range ranging from few Hertz up to a Kilohertz, including sound.
Analysis of fluid fronts and formation permeability as generated by seismo-electric phenomena.

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A method, comprising:
providing an electromagnetic receiver array in a wellbore in a formation;
providing a seismic transmitter source configured to generate seismic waves in the formation;
measuring an electromagnetic field at the electromagnetic receiver array;
activating the seismic source to generate mechanical energy; and
measuring a perturbation in the electromagnetic field at the electromagnetic receiver array, the perturbation being caused by the mechanical energy generated by activating the seismic source.

2. The method according to claim 1, further comprising providing an electromagnetic transmitter to generate the electromagnetic field.

3. The method according to claim 2, further comprising positioning the electromagnetic transmitter in a second wellbore in the formation.

4. The method according to claim 2, further comprising positioning the electromagnetic transmitter in the wellbore.

5. The method according to claim 2, further comprising positioning the electromagnetic transmitter at the surface of the Earth.

6. The method according to claim 1, further comprising synchronizing the electromagnetic receiver array, the electromagnetic transmitter source, and the seismic source.

7. The method according to claim 6, further comprising detecting at the electromagnetic receiver array a plurality of components of the mechanical energy comprising downward-moving direct arrival wave and a primary reflection wave.

8. The method according to claim 1, wherein measuring the electromagnetic field and measuring the perturbation in the electromagnetic field occur substantially simultaneously.

9. The method according to claim 1, isolating the electromagnetic receiver array with one or more centralizers.

10. The method according to claim 1, coupling the electromagnetic receiver array to the formation with one or more clamps.

11. The method according to claim 1, wherein the seismic source comprises one selected from the group of: an air-gun, a vibrating truck, an explosive, a sound source, a drilling bit sound from a second well, an artificial or natural fracture, or a fluid injection induced micro-earthquake.

12. The method according to claim 1, further comprising:
positioning a plurality of seismic sources at the surface;
activating the plurality of seismic sources to generate mechanical energy; and
measuring one or more perturbations in the electromagnetic field at the electromagnetic receiver array, the perturbation being caused by the mechanical energy generated by activating the seismic sources.

13. The method according to claim 1, wherein the electromagnetic field comprises the Earth's naturally occurring electromagnetic field.

14. The method according to claim 1, further comprising positioning the seismic source at the surface.

15. The method according to claim 1, further comprising positioning the seismic source in the wellbore.

16. A system, comprising:
an electromagnetic receiver array disposed in a wellbore in a formation;
a seismic source configured to generate seismic waves in the formation;
wherein the electromagnetic receiver array is configured to measure an electromagnetic field and a perturbation in the electromagnetic field caused by the seismic waves.

17. The system according to claim 16, wherein the seismic source is positioned at the surface of the Earth.

18. The system according to claim 16, wherein the seismic source is positioned in the wellbore

19. The system according to claim 16, further comprising an electromagnetic transmitter configured to generate the electromagnetic field.

20. The system according to claim 19, wherein the electromagnetic transmitter is configured for placement in the wellbore.

21. The system according to claim 19, wherein the transmitter is configured for placement in a second wellbore.

22. The system according to claim 16, wherein the electromagnetic field comprises a naturally occurring magnetic field.

23. The system according to claim 16, further comprising a means for synchronization of the electromagnetic receiver array and the seismic source.

24. The system according to claim 19, further comprising a means for synchronization of the electromagnetic receiver array, the electromagnetic transmitter, and the seismic source.

25. The system according to claim 16, further comprising one or more clamps coupling the electromagnetic receiver array to the formation.

26. The system according to claim 16, further comprising one or more centralizers isolating the electromagnetic receiver array in the wellbore.
